(19) United States
(12) Patent Application Publication
(10) Pub. No.: US 2023/0136028 A1
(43) Pub. Date: May 4, 2023

(54) ERGONOMIC EYES-OFF-HAND MULTI-TOUCH INPUT

(71) Applicant: Jin Alexander Yu, Cupertino, CA (US)

(72) Inventor: Jin Alexander Yu, Cupertino, CA (US)

(21) Appl. No.: 17/980,522

(22) Filed: Nov. 3, 2022

Related U.S. Application Data
(60) Provisional application No. 63/263,450, filed on Nov. 3, 2021.

(51) Int. Cl. G06F 3/041; G06F 3/042; G06F 3/0488

(52) U.S. Cl. CPC G06F 3/04186; G06F 3/0425; G06F 3/0488; G06F 2203/04104; G06F 2203/04804

(57) ABSTRACT

In an embodiment, there is an apparatus for enhanced comfort in operating a computer, the computer including a multi-touch touchscreen, the apparatus including: a camera; and a support member for supporting the camera, the support member configured to position the camera to take video of the back of a user's hand, hereinafter referred to only as hand video, as the user controls the multi-touch touchscreen, the hand video for enhancing video that would normally be for display by the multi-touch touchscreen, the video hereinafter referred to only as pre-hand video, the enhancing to add fingertip position information.

### CROSS REFERENCE TO RELATED APPLICATIONS

This patent claims priority from U.S. Provisional Patent Application 63/263,450, filed 2021 Nov. 3.

### TECHNICAL FIELD

The present invention relates to electronic devices. Embodiments of the present invention relate to tablet computers or smart phone computers or other computers that use multi-touch input surfaces, including multi-touch touchscreens.

### BACKGROUND

Electronic devices that use multi-touch input surfaces, including multi-touch-touchscreen computers (hereinafter, “MTTS computers”) for use by persons, are popular. MTTS computers include, for example, iPhones or iPads by Apple Inc. running the iOS operating system, and smart phones or computers running some variants of the Android operating system, and computers running some variants of the Windows operating system from Microsoft Corp. However, MTTS computers, for example, have a problem.

The problem is that a user who uses an MTTS computer may experience physical non-ergonomic discomfort in several scenarios.

For example, when the multi-touch-touchscreen is in a generally upright position (e.g., oriented similarly to the display of an in-use opened clamshell laptop computer), it can be tiring for the user to raise her arms repeatedly to touch the multi-touch-touchscreen.

For example, when the multi-touch-touchscreen is in a generally prone position (e.g., oriented similarly to the keyboard of an in-use opened clamshell laptop computer), and there is also a separate display monitor in a generally upright position, it can be tiring for the user to repeatedly move and refocus her eyes between the separate display monitor and the multi-touch-touchscreen.

### SUMMARY

Accordingly, there is a need for apparatuses and methods to obtain an improved user experience with MTTS computers.

In some embodiments of the present invention, there is an apparatus for enhanced comfort in operating a computer, the computer including a multi-touch touchscreen, the apparatus including: a camera; and a support member for supporting the camera, the support member configured to position the camera to take video of the back of a user's hand, hereinafter referred to only as hand video, as the user controls the multi-touch touchscreen, the hand video for enhancing video that would normally be for display by the multi-touch touchscreen, the video hereinafter referred to only as pre-hand video, the enhancing to add fingertip position information.

In some embodiments of the present invention, the apparatus further includes a layer that is of a green color or other non-hand color, the layer configured to permit multi-touch operation of the multi-touch touchscreen by fingers, the layer configured to overlay the pre-hand video, the layer making the hand video suitable for chroma-key video capture of the user's hand without background imagery.

In some embodiments of the present invention, the layer that is of the green color or other non-hand color is a physical layer that is opaque or translucent and that is of the green color or other non-hand color.

In some embodiments of the present invention, the layer that is of the green color or other non-hand color is a virtual layer of color that virtually overlays the pre-hand video, the virtual layer being generated by the computer for display to the multi-touch touchscreen.

In some embodiments of the present invention, the apparatus further includes an electronic device configured to composite the hand video with the pre-hand video to produce composited video that when displayed allows the user to know, by viewing the composited video without directly looking at the back of the user's hand, the position of the user's fingertips for operating the multi-touch touchscreen.

In some embodiments of the present invention, the electronic device is configured to composite the hand video using chroma-key to remove the background of the hand in the hand video and using a pre-determined opacity setting on the hand video so that the hand appears to be translucent to the user's eyes.

In some embodiments of the present invention, the electronic device for compositing the hand video includes the computer.

In some embodiments of the present invention, there is a method for enriching display output from a computer, the method including: capturing video of the back of a user's hand as the hand operates a multi-touch input surface to control software running on the computer, the video hereinafter referred to only as hand video; compositing the hand video with video generated by the computer to be displayed to the user, the video hereinafter referred to only as pre-hand video, the compositing producing composited video that when displayed allows the user to know, by viewing the composited video without directly looking at the back of the user's hand, position of the user's fingertips for operating the multi-touch input surface.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIG. 1 is a schematic diagram of an illustrative electronic device in accordance with portions of an embodiment.

FIG. 2 is a schematic diagram illustrating an arrangement for ergonomic multi-touch input in accordance with some embodiments.

FIG. 3 is a schematic flow diagram illustrating a method for enhancing ergonomic multi-touch input in accordance with some embodiments.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will be further understood that the terms “includes,” “including,” “comprises,” and “comprising,” when used in this specification, specify the presence of stated features, but do not preclude the presence or addition of one or more other features and/or groups thereof.

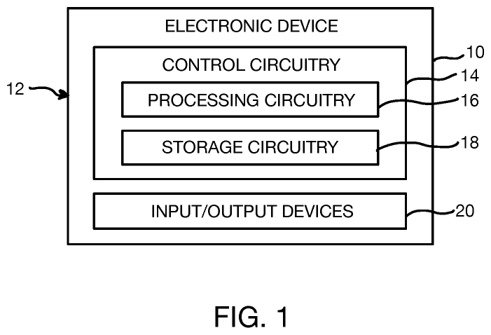

An illustrative electronic device is shown in FIG. 1. Electronic device 10 may be a computing device such as a laptop computer, a computer monitor containing an embedded computer (e.g., a desktop computer formed from a display with a desktop stand that has computer components embedded in the same housing as the display), a tablet computer, a cellular telephone, a media player, or other handheld or portable electronic device, a smaller device such as a wrist-watch device, a pendant device, a headphone or earpiece device, a device embedded in eyeglasses or other equipment worn on a user's head, or other wearable or miniature device, a television, a computer display that does not contain an embedded computer, a gaming device, a navigation device, a tower computer, an embedded system such as a system in which electronic equipment with a display is mounted in a kiosk or automobile, equipment that implements the functionality of two or more of these devices, or other electronic equipment.

As shown in FIG. 1, a device 10 may include components located on or within an electronic device housing such as housing 12. Housing 12, which may sometimes be referred to as a case, may be formed of plastic, glass, ceramics, fiber composites, metal (e.g., stainless steel, aluminum, metal alloys, etc.), other suitable materials, or a combination of these materials. In some situations, parts or all of housing 12 may be formed from dielectric or other low-conductivity material (e.g., glass, ceramic, plastic, sapphire, etc.). In other situations, housing 12 or at least some of the structures that make up housing 12 may be formed from metal elements. Housing 12 may include a frame (e.g., a conductive or dielectric frame), support structures (e.g., conductive or dielectric support structures), housing walls (e.g., conductive or dielectric housing walls), or any other desired housing structures.

Electronic device 10 may have control circuitry 16. Control circuitry 16 may include storage and processing circuitry for supporting the operation of device 10. The storage and processing circuitry may include storage such as hard disk drive storage, nonvolatile memory (e.g., flash memory or other electrically-programmable-read-only memory configured to form a solid state drive), volatile memory (e.g., static or dynamic random-access-memory), etc. Processing circuitry in control circuitry 16 may be used to control the operation of device 10. The processing circuitry may be based on one or more microprocessors, microcontrollers, digital signal processors, baseband processors, power management units, audio chips, application specific integrated circuits, etc. Control circuitry 16 may include wired and/or wireless communications circuitry (e.g., antennas and associated radio-frequency transceiver circuitry such as cellular telephone communications circuitry, wireless local area network communications circuitry, etc.). The communications circuitry of control circuitry 16 may allow device 10 to communicate with keyboards, computer mice, touchpads, including multi-touch touchpads, remote controls, speakers, accessory displays, accessory cameras, and/or other electronic devices that serve as accessories for device 10.

Input-output circuitry in device 10 such as input-output devices 20 may be used to allow data to be supplied to device 10 and to allow data to be provided from device 10 to external devices. Input-output devices 20 may include input devices that gather user input and other input and may include output devices that supply visual output, audible output, or other output. These devices may include buttons, joysticks, scrolling wheels, touch pads, including multi-touch touchpads, key pads, keyboards, microphones, speakers, tone generators, vibrators and other haptic output devices, light-emitting diodes and other status indicators, data ports, etc.

Input-output devices 20 may include one or more displays such as displays, touchscreens, etc. Devices 20 may, for example, include an organic light-emitting diode display with an array of thin-film organic light-emitting diode pixels, a liquid crystal display with an array of liquid crystal display pixels and an optional backlight unit, a display having an array of pixels formed from respective crystalline light-emitting diodes each of which has a respective crystalline semiconductor light-emitting diode die, and/or other displays. In some configurations, input-output devices 20 may include a projector display based on a micromechanical systems device such as a digital micromirror device or other projector components.

Input-output devices 20 may include a touch screen display that includes a touch sensor for gathering touch input from a user or a touch insensitive display that is not sensitive to touch. A touch sensor for display may be based on an array of capacitive touch sensor electrodes, acoustic touch sensor structures, resistive touch components, force-based touch sensor structures, a light-based touch sensor, or other suitable touch sensor arrangements.

Input-output devices 20 may also include sensors. Sensors may include force sensors (e.g., strain gauges, capacitive force sensors, resistive force sensors, etc.), audio sensors such as microphones, touch and/or proximity sensors such as capacitive sensors (e.g., a two-dimensional capacitive touch sensor integrated into a display, a two-dimensional capacitive touch sensor overlapping the display, and/or a touch sensor that forms a button, trackpad, or other input device not associated with a display), and other sensors. If desired, sensors may include optical sensors such as optical sensors that emit and detect light, ultrasonic sensors, optical touch sensors, optical proximity sensors, and/or other touch sensors and/or proximity sensors, monochromatic and color ambient light sensors, image sensors, fingerprint sensors, temperature sensors, sensors for measuring three-dimensional non-contact gestures (“air gestures”), pressure sensors, sensors for detecting position, orientation, and/or motion (e.g., accelerometers, magnetic sensors such as compass sensors, gyroscopes, and/or inertial measurement units that contain some or all of these sensors), health sensors, radio-frequency sensors (e.g., sensors that gather position information, three-dimensional radio-frequency images, and/or other information using radar principals or other radio-frequency sensing), depth sensors (e.g., structured light sensors and/or depth sensors based on stereo imaging devices), optical sensors such as self-mixing sensors and light detection and ranging (lidar) sensors that gather time-of-flight measurements, humidity sensors, moisture sensors, gaze tracking sensors, three-dimensional sensors (e.g., pairs of two-dimensional image sensors that gather three-dimensional images using binocular vision, three-dimensional structured light sensors that emit an array of infrared light beams or other structured light using arrays of lasers or other light emitters and associated optical components and that capture images of the spots created as the beams illuminate target objects, and/or other three-dimensional image sensors), facial recognition sensors based on three-dimensional image sensors, and/or other sensors. In some arrangements, device 10 may use sensors and/or other input-output devices to gather user input (e.g., buttons may be used to gather button press input, touch sensors overlapping displays can be used for gathering user touch screen input, touch pads may be used in gathering touch input, microphones may be used for gathering audio input, etc.).

If desired, electronic device 10 may include additional components (see, e.g., other devices in input-output devices 20). The additional components may include haptic output devices, audio output devices such as speakers, light sources such as light-emitting diodes (e.g., crystalline semiconductor light-emitting diodes for status indicators and/or components), other optical output devices, and/or other circuitry for gathering input and/or providing output. Device 10 may also include an optional battery or other energy storage device, connector ports for supporting wired communications with ancillary equipment and for receiving wired power, and other circuitry. Device 10 may be operated in systems that include wired and/or wireless accessories (e.g., keyboards, computer mice, remote controls, trackpads, etc.).

An instantiation of electronic device 10 may be an MTTS computer with which an apparatus according to an embodiment of the present invention operates, to enrich the experience and to enrich the display output of the MTTS computer. An instantiation of electronic device 10 may be an electronic device that forms a part of an apparatus according to embodiment of the present invention, that operates with a separate MTTS computer, to enrich the experience and to enrich the display output of the MTTS computer. An instantiation of electronic device 10 may be an electronic device that forms a part of an apparatus according to embodiment of the present invention, the electronic device itself being an MTTS computer whose display output is enriched, as compared to prior MTTS computers not according to the present invention.

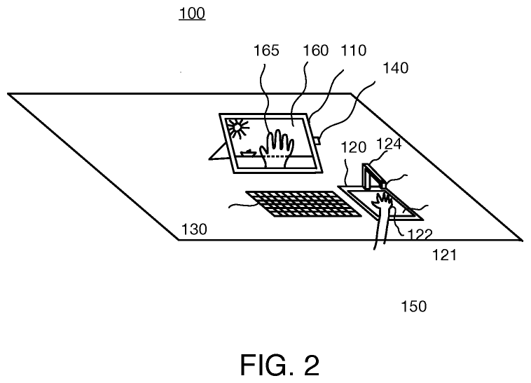

Attention is now directed toward some embodiments of the present invention. FIG. 2 is a schematic diagram illustrating an arrangement 100 for ergonomic multi-touch input in accordance with some embodiments of the present invention. A primary viewing-screen device 110 and a primary multi-touch input ensemble 120 cooperate to enable ergonomic multi-touch input for an MTTS computer. An optional external keyboard 130 may be used.

Some embodiments type 1: Green-screen Camera apparatus for MTTS Computer

In some embodiments of type 1, the primary multi-touch input ensemble 120 includes one MTTS computer 121 (e.g., an iPhone or iPad) with an apparatus that includes a camera 122, supported by a support member 124. The apparatus may be, for example, a case or a clamp that removably physically engages with the MTTS computer 121. The case or clamp may be of any design such as is found in “protective cases” or camera tripod clamps, using materials and as described for example for the electronic-device case 12 of FIG. 1. The apparatus may include a layer, e.g., a physical layer (e.g., of plastic or glass), akin to a “screen protector”, that covers the screen of the MTTS computer 121 while still permitting multi-touch function. The layer may be opaque or near-opaque green (or other non-skin color) such that the video captured by the camera 122 would be of the user's hand 150 against a green (or other non-skin color) background, suitable for chroma-key processing to retain video of the hand 150 and to remove the video of the green background. The background may be removed by any background-removal algorithm; chroma-key algorithm is just one example. The support member 124 is configured to maintain position of the camera 122 relative to MTTS computer 121 to capture the desired video. If the hand 150 is to be gloved, then non-skin color would include non-glove-color. The apparatus includes a proximity detector, for example an optical (LED or laser) detector that detects when any finger of the user's hand 150 is within a pre-set distance from the touchpad surface, for example, 1 centimeter. For example, the optical detector may have LEDs shine from one side (e.g., left) of the MTTS computer 121 (in landscape mode) onto receptors in the other side (e.g., right) of the MTTS computer 121, and fingers would interrupt the reception by the receptors when they get close to the touch screen of the MTTS computer 121. The LEDs and receptors may be housed in a raised fence that rises on the two sides of the MTTS computer 121, the raised fence being part of the case or clamp of the apparatus. In some embodiments, the layer is a virtual green layer that refers to a green color that the MTTS computer 121 is instructed to display on its screen, upon the user invoking an “eyes-off-hands” mode according to the present invention. In such embodiments, the MTTS computer 121 contains software that implements the methodology of the present invention as described in the present document, according to computer programming practice.

In some embodiments, the primary viewing-screen device 110 is an external video monitor that accepts as input video that is output from the MTTS computer and also from the camera 122. The external video monitor may accept input from a video input mixer 140 that is configured to accept two inputs, one from the MTTS computer 121 and one from the camera 122, either by cable or wirelessly. The video input mixer 140 may be an electronic device of the type described in FIG. 1. The video input mixer 140, in some embodiments, may form part of the apparatus within the primary multi-touch input ensemble 120.

In operation, the MTTS computer 121 is driving the external video monitor in the usual way for doing so. If and when the proximity detector indicates that there is a finger within the pre-set distance from the touch pad surface—i.e., near to the surface, the apparatus uses its camera 122 to capture video of the user's hand 150 against the green background and sends this green-screen video to the mixer 140 via video-capable cable or wireless connection (e.g., WiFi), and the mixer 140 composites the green-screen video with the usual video output of the MTTS computer 121 to form a composite video for display by the primary viewing-screen device 110 which displays the composite video. As shown in FIG. 2, the composite video shows the usual video output overlayed with a translucent moving image 165 of the user's hand. The opacity of the user's hand in the compositing may be controlled by a user-settable predetermined value, for example a value between 0% and 100%. In this way, the user needs not look at the MTTS computer 121. In fact, the composite video is better than using an MTTS computer in the normal way, because the composite video allows the user to see “through” her own hand to see the displayed image that otherwise would be covered by the hand without the present invention.

Some embodiments type 2: Green-screen Camera Multi-Touch Touch pad Peripheral

In some embodiments of type 2, the primary viewing-screen device 110 is an MTTS computer, (e.g., an iPad or iPhone) and the primary multi-touch input ensemble 120 is a separate peripheral that is a green (or other non-skin color) multi-touch touchpad with the same functionality in its apparatus (including support member 124 and camera 122) as described for some embodiments of type 1.

Some further embodiments: Methods

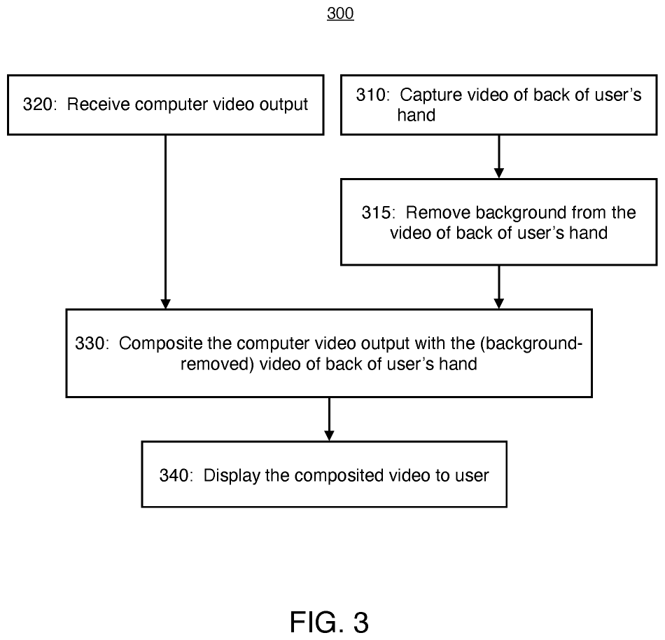

As shown in FIG. 3, there is a method 300 that includes: 310 capturing video of the back of a user's hand, 315 removing background from video of the back of the user's hand, 320 receiving computer video output, 330 compositing the computer video output with the (background removed) video of the back of the user's hand.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to explain the principles of the invention and its practical applications, to thereby enable others skilled in the art to utilize the invention and various embodiments with various modifications as are suited to the particular use contemplated.

I claim:

1. An apparatus for enhanced comfort in operating a computer, the computer including a multi-touch touchscreen, the apparatus including:
a camera; and
a support member for supporting the camera, the support member configured to position the camera to take video of the back of a user's hand, hereinafter referred to only as hand video, as the user controls the multi-touch touchscreen, the hand video for enhancing video that would normally be for display by the multi-touch touchscreen, the video hereinafter referred to only as pre-hand video, the enhancing to add fingertip position information.

2. The apparatus of claim 1, the apparatus further including:
a layer that is of a green color or other non-hand color, the layer configured to permit multi-touch operation of the multi-touch touchscreen by fingers, the layer configured to overlay the pre-hand video, the layer making the hand video suitable for chroma-key video capture of the user's hand without background imagery.

3. The apparatus of claim 2, wherein the layer that is of the green color or other non-hand color is a physical layer that is opaque or translucent and that is of the green color or other non-hand color.

4. The apparatus of claim 2, wherein the layer that is of the green color or other non-hand color is a virtual layer of color that virtually overlays the pre-hand video, the virtual layer being generated by the computer for display to the multi-touch touchscreen.

5. The apparatus of claim 2, the apparatus further including:
an electronic device configured to composite the hand video with the pre-hand video to produce composited video that when displayed allows the user to know, by viewing the composited video without directly looking at the back of the user's hand, the position of the user's fingertips for operating the multi-touch touchscreen.

6. The apparatus of claim 5, wherein the electronic device is configured to composite the hand video using chroma-key to remove the background of the hand in the hand video and to use a pre-determined opacity setting on the hand video so that the hand appears to be translucent to the user's eyes in the composited video.

7. The apparatus of claim 6, wherein the electronic device for compositing the hand video includes the computer.

8. The apparatus of claim 1, further including an electronic device configured to composite the hand video with the pre-hand video to produce composited video that when displayed allows the user to know, by viewing the composited video without directly looking at the back of the user's hand, the position of the user's fingertips for operating the multi-touch touchscreen, wherein the electronic device is configured to composite the hand video to remove the background of the hand in the hand video.

9. The apparatus of claim 8, wherein the electronic device for compositing the hand video includes the computer.

10. A method for enriching display output from a computer, the method including:
capturing video of the back of a user's hand as the hand operates a multi-touch input surface to control software running on the computer, the video hereinafter referred to only as hand video;
compositing the hand video with video generated by the computer to be displayed to the user, the video hereinafter referred to only as pre-hand video, the compositing producing composited video that when displayed allows the user to know, by viewing the composited video without directly looking at the back of the user's hand, position of the user's fingertips for operating the multi-touch input surface.
